(19) United States
(12) Patent Application Publication
(10) Pub. No.: US 2007/0067707 A1
(43) Pub. Date: Mar. 22, 2007

(54) Synchronous digital annotations of media data stream

(75) Inventors: James Travis, Bellevue, WA (US); Michael Wasson, Bellevue, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/229,095

(22) Filed: Sep. 16, 2005

(51) Int. Cl. G06F 15/00

(52) U.S. Cl. 715/500.1; 715/512

(57) ABSTRACT

Synchronous digital ink and audio annotations of media data stream. A media data stream is rendered. The media data stream includes media data organized in one or more segments. Annotating data is received from a user for annotating the media data. A time is identified when the annotating data is received. The identified time is relative to a time corresponding to the one or more segments of the media data as the media data stream is being rendered. An annotating data stream is organized to include the annotating data synchronized with the media data stream based on the identified time. A new file is created that includes the original media data stream and the annotating data stream, or the annotating data stream is added to the original file and saved to a storage area.

### BACKGROUND

Digital commenting and annotating have evolved from the traditional typewritten editing to handwritten commenting and annotating. For example, technologies such as digital ink are able to represent handwriting in its natural form through input devices such as a stylus or similar device to allow a user to input handwritten strokes on a display (e.g., a liquid crystal display (LCD) screen). The movement of the handwritten strokes is recorded as an image or may be transformed to typewritten texts via handwritten recognition technology.

While handwritten annotation was known, prior systems are directed to annotation of documents or non-moveable objects. For example, prior systems permit annotation or editing comments on text files or graphic objects, such as an image file or a graphical design. Such systems lack abilities to synchronously annotate media data streams, such as audio files or video files where images are rendered as a function of time.

Other systems create links between physical objects, such as paper or x-ray film, and digital media, such as an electronic file. These systems merely permit a user to annotate on a physical object (e.g., a piece of paper) and add a link of the user's annotation on a digital representation (e.g., a text or video file) of the physical object.

### SUMMARY

Embodiments of the present invention overcome the shortcomings of prior systems by allowing annotation of a media data stream in real time and creating a separate data stream of annotation of the media data stream. In particular, aspects of the invention store data representing digital ink strokes, audio recordings, or motion picture clips as a separate data stream in a format similar to the media data stream. As such, digital ink strokes, audio recordings, or motion picture clips are captured synchronously relative to the media data stream as the media data stream is rendered. Alternative aspects of the invention provide plug-ins to enable reproducing or rendering of the captured digital ink segments or frames in a digital media player that does not have the capability to render the annotated data stream.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating a system of annotating of media data according to an embodiment of the invention.

FIG. 2 is a block diagram illustrating an exemplary architecture for annotating of media data according to an embodiment of the invention.

FIG. 3A is a diagram illustrating synchronous capturing of annotating data stream according to an embodiment of the invention.

FIG. 3B is a diagram illustrating an exemplary data structure for a captured annotating data stream according to an embodiment of the invention.

FIG. 4 is a diagram illustrating an exemplary interface for annotating media data and rendering of annotated stream according to an embodiment of the invention.

FIG. 5 is an exemplary flow chart illustrating operation of annotating data stream according to an embodiment of the invention.

FIG. 6 is a block diagram illustrating an exemplary computer-readable medium on which aspects of the invention may be stored.

An Appendix A illustrates an exemplary set of programming code for capturing digital ink strokes according to an embodiment of the invention.

Corresponding reference characters indicate corresponding parts throughout the drawings.

### DETAILED DESCRIPTION

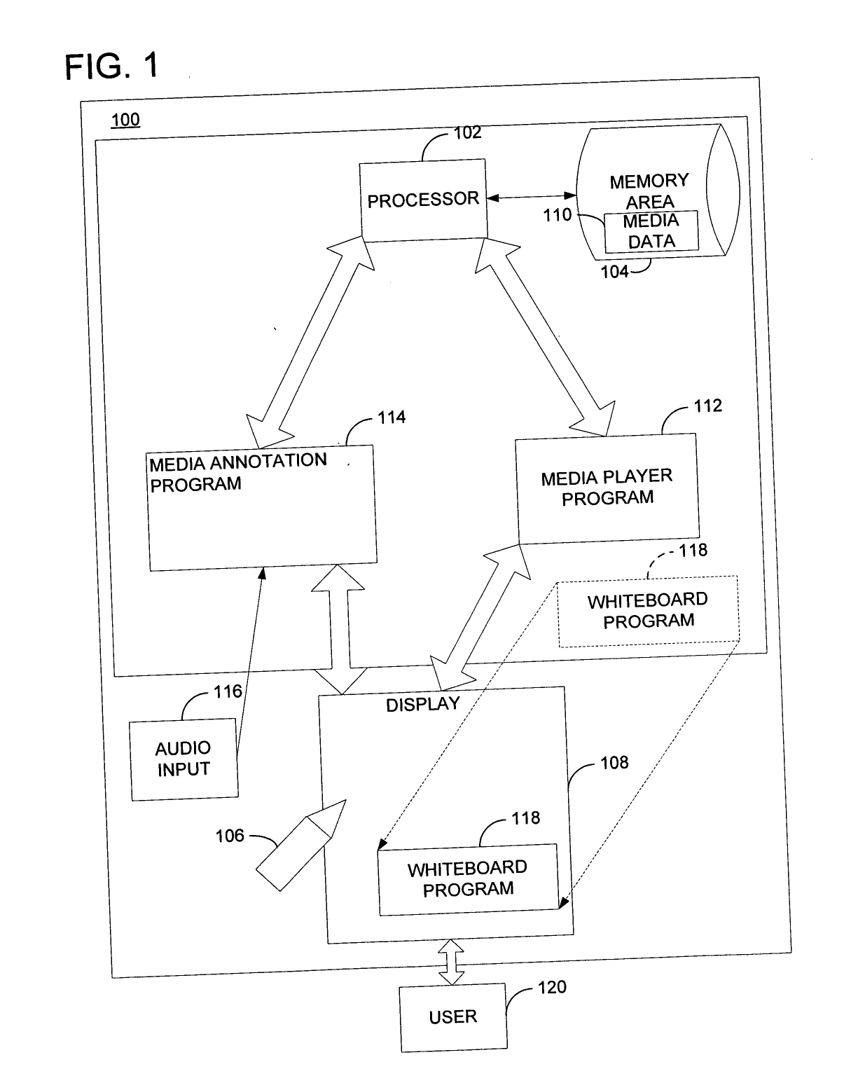

Referring first to FIG. 1, a diagram illustrates a system 100 for annotating media data according to an embodiment of the invention. The system 100 may include a general purpose computing device in the form of a computer. In one embodiment, system 100 has one or more processing units or processors 102 and a system memory area 104. As known to those skilled in the art, system 100 may also include a system bus (not shown) coupling the system memory area 104 and the processor 102 with various system components, such as an input device (e.g., a keyboard, a microphone, or a stylus 106), an output device (e.g., an LCD display 108), additional computer-readable storage medium (e.g., both volatile and nonvolatile media, removable and non-removable media), communication interface or source (e.g., wired or wireless communication interfaces for transmitting signals), and/or other components or devices. In one embodiment, system 100 is a tablet PC which includes a LCD screen sensitive to a special-purpose pen for capturing movement of the pen as the pen moves on the surface of the LCD screen.

For example, the memory area 104 includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by system 100. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The processor 102 is configured to execute computer-executable instructions, routines, application programs, software, computer-executable instructions codes, or program modules. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In another embodiment, the processor 102 is generally programmed by means of instructions stored at different times in the various computer-readable storage media of the system 100. Programs and operating systems are typically distributed, for example, on floppy disks or CD-ROMs. From there, they are installed or loaded into the secondary memory of a computing device. At execution, they are loaded at least partially into the computer's primary electronic memory. Aspects of the invention described herein includes these and other various types of computer-readable storage media when such media contain instructions or programs for implementing the steps described below in conjunction with a microprocessor or other data processor.

For example, system 100 includes a media data stream/file 110, which may be an audio file, a video clip, a motion picture file, or a series of graphic images (e.g., a slide show) stored on a computer-readable readable medium. In an alternative embodiment, the media data stream/file 110 (hereinafter “media data stream”) may be a live media stream transmitted from a broadcasting source in a distributed system via the common communication network. The processor 102 executes a media player program 112 for rendering media data stream 110. For example, the media player program 112 may be audio playback software or a set of instructions or video rendering software for playback of motion picture.

The system 100 also includes a media annotation component or program 114 for capturing annotations as the media data stream 110 is rendered and for reproducing the annotated stream. For example, a user 120 may use the stylus 106 to write on the display 108 to annotate the media data stream 110 as it is being rendered by the media player program 112. In another embodiment, the user 120 can also simultaneously or substantially simultaneously use the stylus 106 to write on a whiteboard program or software 118 and to comment on the media data stream 110. In yet another embodiment, the user 120 can also simultaneously or substantially simultaneously speak to a microphone or other audio input device 116 to record audio comments, narrations, or commentaries as the media data stream 110 is rendered. After such annotations, the user 120 executes the media player program 112 with the media annotation component or program 114 to render the annotated stream.

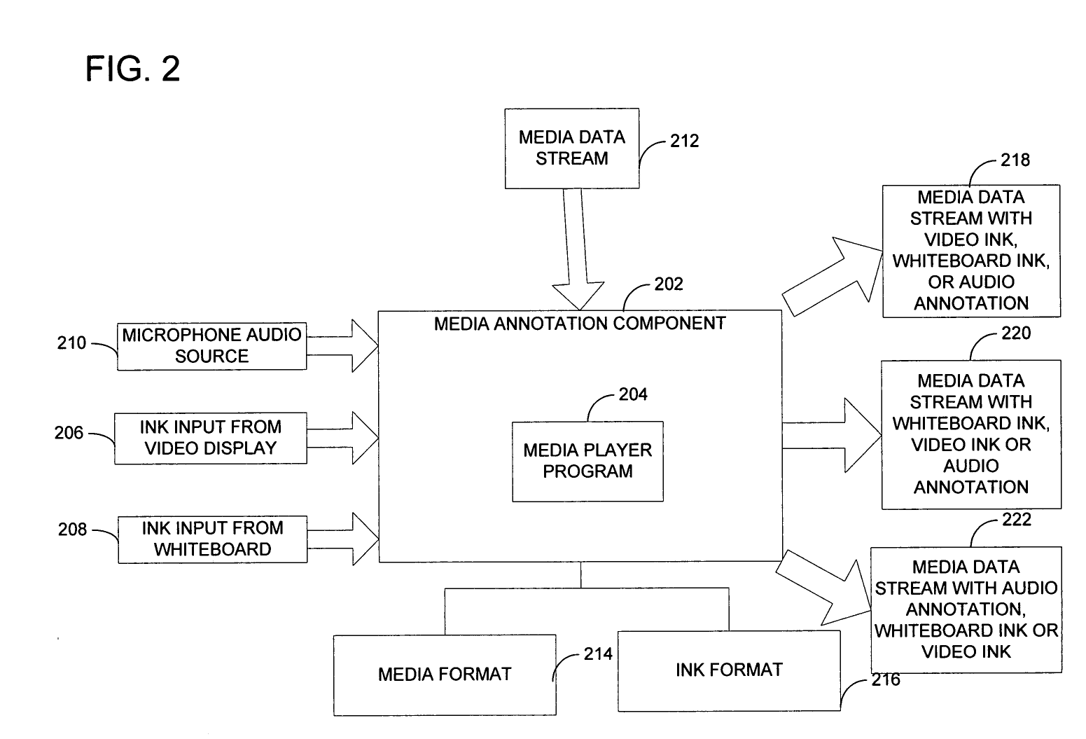

FIG. 2 is a block diagram illustrating an exemplary architecture for annotating media data according to an embodiment of the invention. For example, the architecture includes a media annotation component or program 202 which includes formatting standards of a media format 214 and an ink format 216. In one embodiment, the media annotation component 202 is an internal or external component of a media player program 204, which renders media data streams. The media annotation component 202 receives annotating data from a digital ink input via a video display 206, a digital ink input via a whiteboard application program 208, or an audio input via a microphone or an audio source 210. A media data stream 212 is rendered in one or more segments or frames. The media annotation component 202 also includes a digital ink overlay window to capture and reproduce digital ink drawn on the whiteboard application program 118.

Initially, when the user 120 wishes to annotate the media data stream 212, the media player program 204 renders the media data stream 212. For example, the user 120 may wish to comment on a series of video clips. As the video clips are rendered, a buffer or a memory area monitors the rendering progress and records time periods/timestamps of segments of the media data stream 212 as it is being rendered. Next, the user 120 may use the stylus 106 or other input device to write or move on the display 108. The media annotation component 202 captures the movement of the stylus 106 in real time. The captured movements of the stylus 106 is stored in a data structure (e.g., a queue) and a time stamp or time period is identified in which the annotating data is captured/received relative to the time as the media data stream 212 is rendered. For example, Appendix A illustrates an exemplary set of programming code for capturing digital ink strokes. In one embodiment, the user 120 may use the stylus 106 to write on a whiteboard program area (e.g., the phantom lines showing the whiteboard program area 118 on the display 108) for annotating the media data stream 212 while it is being rendered by the media player program 204. In particular, media annotation component 202 may periodically sample or capture digital ink movements at a predetermined time period.

In yet another embodiment, the user 120 may use a microphone to record audio recordings as a means for annotating. For example, an audio recording may be buffered by using an audio capture application programming interface (API), such as DirectSound®. The sample audio is queued in a custom data structure using a programming construct such as a linked list. As such, embodiments of the invention provide animated and versatile means for annotating media data stream 212 (e.g., video clips, music files, slide shows, or the like) by storing or organizing the annotating data, such as digital ink on a video display, digital ink on a whiteboard, or a voice/audio recordings in the data structure with time stamps.

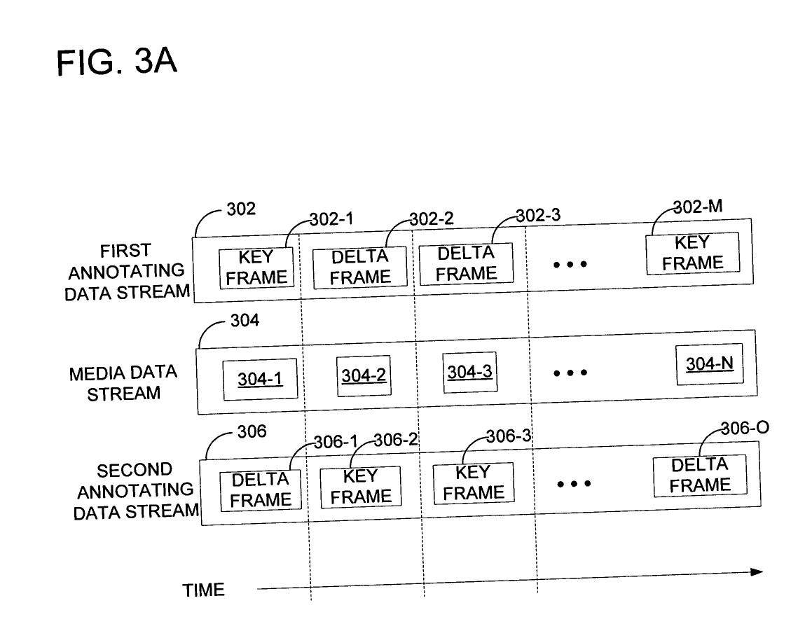

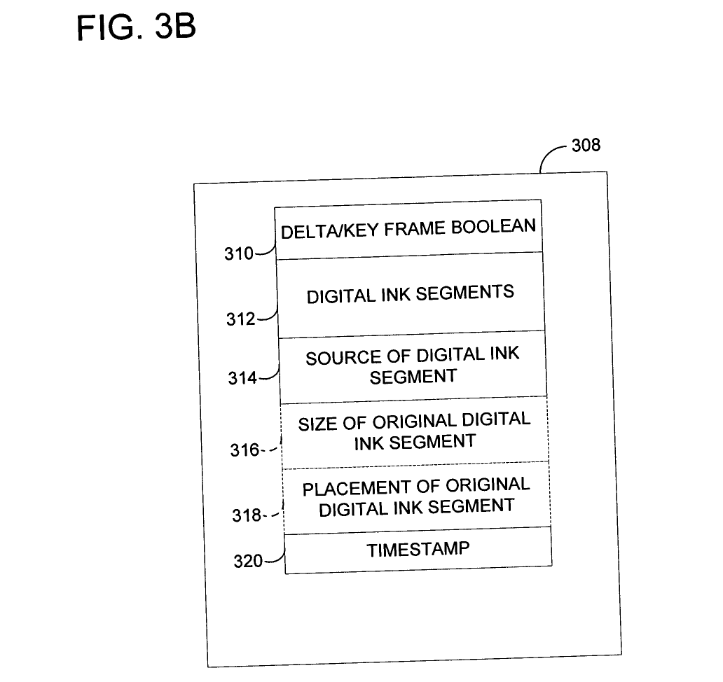

As the user 120 annotates the media data stream 212, the annotating data (e.g., digital ink movements or audio recordings) is stored in the data structure and is organized as an annotating data stream. In one example, the user 120 may remove previously stored annotating data in the annotating data stream from the data structure (to be discussed in further detail in FIG. 3B below). As such, unlike previous systems where only an anchor or a link is created in the digital file, embodiments of the invention generate a separate annotating data stream to be rendered synchronously with the media data stream 212.

Once the user 120 finishes annotating the media data stream 212, the media annotation component 202 generates an annotated media file, which includes the original media data stream 212 and the annotating data stream synchronized with the media data stream 212 based on the identified time period. In one embodiment, the annotating data stream or the annotated media file may have a custom digital media format including digital ink segments or frames for the video display, whiteboard area, and audio recordings. In another embodiment, the resulting annotated media file may be formatted as the original media data stream 212, but includes the annotating data stream and the original media data stream 212. In an alternative embodiment, the resulting annotated media file is an updated version of the original media data stream 212.

While aspects of the invention are described with respect to creating or forming the annotating data stream independent of the media data stream, the annotating data stream may be implemented by incorporating in, supplementing to, attaching to, or linking to the media data stream 212 without departing from the scope of the invention.

The annotating data stream may include different types of annotations to the media data stream 212. For example, if the user 120 annotates a series of video clips directly on the display area of media player program 204 while the media player program 204 is rendering the media data stream 212, the media annotation component 202 renders a resulting annotated media file 218 to include the media data stream 212 and a synchronized annotating data stream 206 of the user's scribbling or annotation of the video clips. In another example, the user 120 may create an annotated media file 220, which includes the media data stream 212 and a synchronized annotating data stream 208 (i.e., whiteboard digital ink annotation). In a further example, the user 120 may annotate the media data stream 212 by recording the user's 120 voice to generate an annotated media file 222, which includes the media data stream 212 and a synchronized audio annotation data stream 210. While the annotated media files 218, 220, and 222 are illustrated to include that annotating data stream 206, 208, and 210, respectively, each annotated media file (e.g., 218, 220, and 222) may include a combination of annotating data stream 206, 208, and/or 210 without departing from the scope of the invention. In one embodiment, the annotated media files 218, 220, and 222 are in an advanced systems format (ASF) file format, which may include annotating data stream, media data stream 212, and/or additional data stream or information thereof.

Referring now to FIG. 3A, a diagram illustrates synchronous capturing of first and second annotating data streams with a media data stream according to an embodiment of the invention. A media data stream 304 (e.g., a video clip or an audio data stream/file) is being rendered by the media player program 204. The media data stream 304 is rendered as one or more segments or frames 304-1, 304-2, to 304-N. The media annotation component 202 captures the annotating data and the annotating data is organized in one or more annotating data streams and stored in the data structure. Each annotating data stream (e.g., first annotating data stream 302, having segments 302-1 to 302-M, and second annotating data stream 306, having segments 306-1 to 306-O), being organized in one or more segments, includes annotating data and the time stamp or time period associated with a corresponding segment of the media data stream. For example, as illustrated, a segment 302-1 of the annotating data stream 302 has information representing a key frame (see discussion of key frame in FIG. 3B below) and a time stamp associated with the segment 304-1 of the media data stream 304. Other segments (e.g., 302-2 or 302-3) of the annotating data stream 302 includes information representing key frame or delta frame and time stamps associated with corresponding segments of the media stream 304. In a similar illustration, a segment 306-1 of the annotating data stream 306 has information representing a delta frame (see discussion of delta frame in FIG. 3B below) and a time stamp associated with the segment 304-1 of the media data stream 304. Other segments (e.g., 306-2 or 306-3) of the annotating data stream 306 includes information representing key frame or delta frame and time stamps associated with corresponding segments of the media stream 304. It is also to be understood that each segment may include information representing a delta frame or a key frame.

FIG. 3B illustrates an exemplary data structure 308 for a captured annotating data stream according to an embodiment of the invention. For example, as the user 120 uses the stylus 106 to write on the display 108 or on the whiteboard area 108, annotating data is captured and the data structure 308 to form an annotating data stream. In one embodiment, a header of the annotating data input (e.g., on display, whiteboard, or audio source) is associated with a globally unique identifier (GUID) identifying a media type. Individual segments or frames of the annotating data are stored in a field 312. The data structure 308 defines a field 314 that identifies the source of the digital ink frame, such as the video or the whiteboard. In addition, the data structure 308 defines a field 320 for storing the time stamp associated with each segment of the annotating data stream with respect to the media data stream 212. Also, the data structure 308 includes a field 310 for storing information about whether the data field represents a key frame or a delta frame. A key frame includes all of the information needed to reconstruct the digital ink that was captured at the time corresponding to the time stamp. A delta frame includes only the differences between the current frame and the previous frame, and requires the previous frame in order to reconstruct the complete digital ink information. In one embodiment, there is a true/false field (Boolean) that identifies which type of data (i.e., key frame or delta frame) is stored in the field 310. The data structure 308 may optionally include a field 316 and a field 318 for information about the size and placement of the original ink frame, respectively, to enable scaling during reproduction or rendering. A default size may be assumed if the media player program 204 or the media annotation component 202 defines it. As such, for each annotating data stream, the data structure 308 includes information of the annotating data stream so that the media player program 204 or the media annotation component 202 may properly render the annotating data stream with the media data stream.

Embodiments of the invention advantageously capture handwritten or voice recorded annotation of media data stream. Aspects of the invention can be operated to render the annotated data stream during the playback of the media data stream. For example, one embodiment of the invention includes a system for rendering digitally annotated media file.

An interface (e.g., a LCD screen, a whiteboard application, a media player program) receives the annotated media file, and annotated media file includes an annotating data stream and a media data stream. A processor executes computer-executable instructions for identifying the annotating data stream. The annotating data stream is organized in one or more segments each having a time stamp associated therewith. The processor also executes computer-executable instructions for rendering the media data stream, and the media data stream includes media data being rendered in one or more segments. The one or more segments of the annotating data stream and the corresponding segments of the media data stream are rendered synchronously by associating each of the time stamps of the annotating data stream with each of the segments of the media data stream. A user interface (e.g., a display 108 or a set of speakers) provides the rendered annotating data stream and the rendered media data stream to the user 120.

In another example, embodiments of the invention may be incorporated in a system such as a digital media player, a media rendering electronic apparatus, a device, a computing device, an application component, or software for playback of the media data stream for rendering both the media data stream and the annotating data stream. For example, such a system may be media player software, a CD player, or a DVD player. In such an embodiment, the annotating data stream may be embedded or included in a computer-readable storage medium and the system recognizes such annotating data stream and render accordingly. In another example, a plug-in component or an add-on component may be added to the rendering device to provide the capability to render the annotating data stream.

As such, in rendering or in playback of the annotated stream, the annotating data stream may include a combination of digital ink drawings on video display or on whiteboard, or audio annotations, and is rendered in an animated and synchronized fashion while playing back the original digital media data streams.

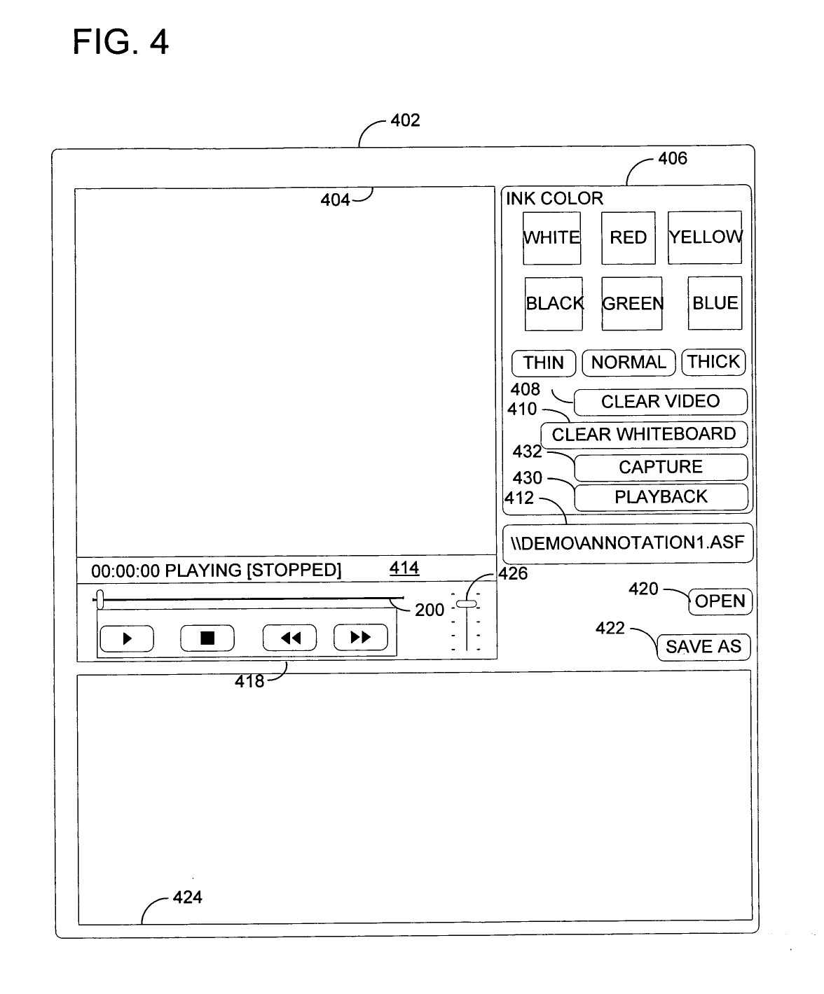

FIG. 4 is an exemplary interface 402 for annotating media data and rendering of annotated stream according to an embodiment of the invention. The interface 402 includes a set of mode selection buttons: a “capture mode” button 432 or a “playback mode” button 430. For example, in the playback mode, the interface 402 may be combined with a media data rendering area 404 for rendering the media data stream only. In the capture mode, the interface 402 may interface with the media annotation component 202 to capture annotating data (e.g., digital ink strokes/movements) while the media player program 20 renders the media data stream. The interface 402 also includes a playback status bar 414, a playback progress indicator 416, a volume control 426, and a set of playback operation controls 418. For example, the set of controls 418 includes play, stop, fast forward (or forward), and fast rewind (or rewind) operations. For example, as the user 120 annotates the media data stream 212, the user 120 may select the “fast rewind” operation, or by dragging the progress indicator 416, to rewind the media data stream 212, which would also synchronously rewind the annotating data that was previously recorded. Other playback operation controls (e.g., pause) may also be included.

In an alternative embodiment, an advanced feature of the set of playback operation controls 418 is included. For example, in “fast rewind” or “rewind” operation, instead of having a snapshot of what was previously captured annotating data, an alternative embodiment of the invention may compare the previous captured annotating data (e.g., digital ink strokes) such that, in rewinding, the user 120 would see a gradual and more animated rewinding operation.

The interface 402 also includes a set of digital ink properties 406 having a color palette for providing one or more choice of digital ink colors (e.g., white, blue, black, red, green, and yellow) and an ink line width property (e.g., thin, normal, or thick). A whiteboard window 424 captures and/or reproduces whiteboard annotations. The whiteboard window 424 may simply be a region in an application or a standalone window. The background color of the whiteboard window 424 may be in a white or any other color.

A “clear video” button 408 and a “clear whiteboard” button 410 allow the user 120 to erase or remove what is currently shown on the writing regions, much like one would erase a blackboard by rubbing off all the chalk with a felt eraser. In an alternative embodiment, additional erasing features can remove all previously recorded or stored annotating data. As discussed above with respect to removing annotating data from the data structure, the interface 402 provides a convenient way to erase unwanted annotating data and start annotating from scratch again. The user 120 may use an “open” button 420 to open file including an annotated data stream or a media data stream as indicated by a file location field 412. The user 120 may also use a “save as” button 422 for storing an annotating data stream as an existing or a new file.

In one embodiment, the interface 402 includes interfaces of the media player program 204, the media annotation component 202, the whiteboard application program 118, and or an audio input device (e.g., a microphone).

While the interface 402 is illustrated as shown in FIG. 4, other graphical user interface designs or schemes with additional functionalities or advanced features may be implemented without departing from the scope of the invention.

In operation, embodiments of the invention may be operated in the following manner. A user may be an advertising executive and hires a director to create a television advertisement. The director may encode a TV advertisement video using a media player and transmits the video as a video file to the user. By using aspects of the invention, the user views the video file on a computing device (e.g., a Tablet PC) while using a digital ink (e.g., a stylus 106) to draw and write on the video images/clips to add annotations. The user may also draw and write on a separate whiteboard area to add additional annotations. For example, the annotations may inform the director how to rearrange shots in the video or change product placements in one or more individual shots in the video. The user may even record his voice comments at the same time. After the user finishes his annotations of the TV advertisement video with video annotation, whiteboard annotations, or voice recordings, the user saves the annotating data streams and the original TV advertisement video as one output file. For example, the output file would be an annotated video file including the annotating data stream (e.g., digital ink annotations on the video and/or whiteboard, and/or audio recordings) and the original video file.

When finished, the user may transmit the annotated video file to the director. The director may subsequently view the annotated video file on her own Tablet PC or simply on a desktop PC or other computing device. When the annotated video file is rendered, the director would see the user's digital ink markings reproduced in real time as the original TV advertisement video is rendered. In other words, the digital ink markings are reproduced in an animated fashion, as if a “ghost hand” were doing the writing. The markings, unlike traditional and existing systems, do not appear all at once and change over time like a slide show. The director would also hear the user's recorded audio comments at the same time. In this way, the user and the director can work together across space and time through lively and real time annotation of media data streams. In one embodiment, the director may need a plug-in or add-on component to view or listen to the annotating data stream in the annotated video file.

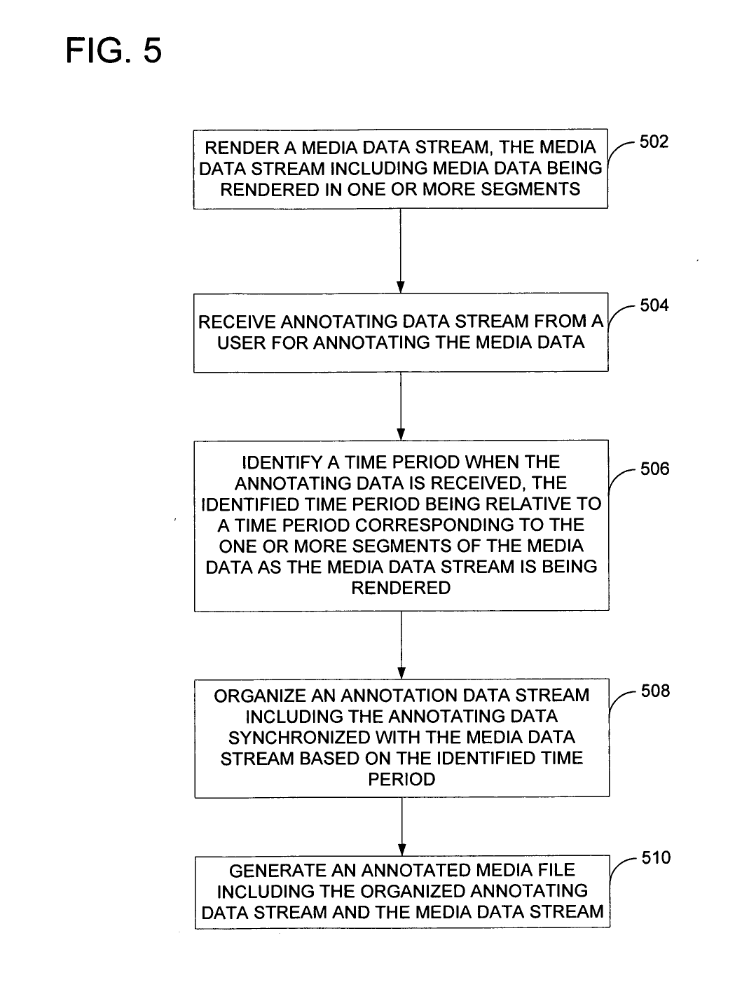

FIG. 5 is an exemplary flow chart illustrating operations of annotating data stream according to an embodiment of the invention. At 502, a media data stream is rendered. The media data stream includes media data organized in one or more segments. Annotating data is received from a user for annotating the media data at 504. At 506, a time period is identified when the annotating data is received. The identified time period is relative to a time corresponding to the one or more segments of the media data as the media data stream is being rendered. An annotating data stream is organized including the annotating data synchronized with the media data stream based on the identified time period at 508.

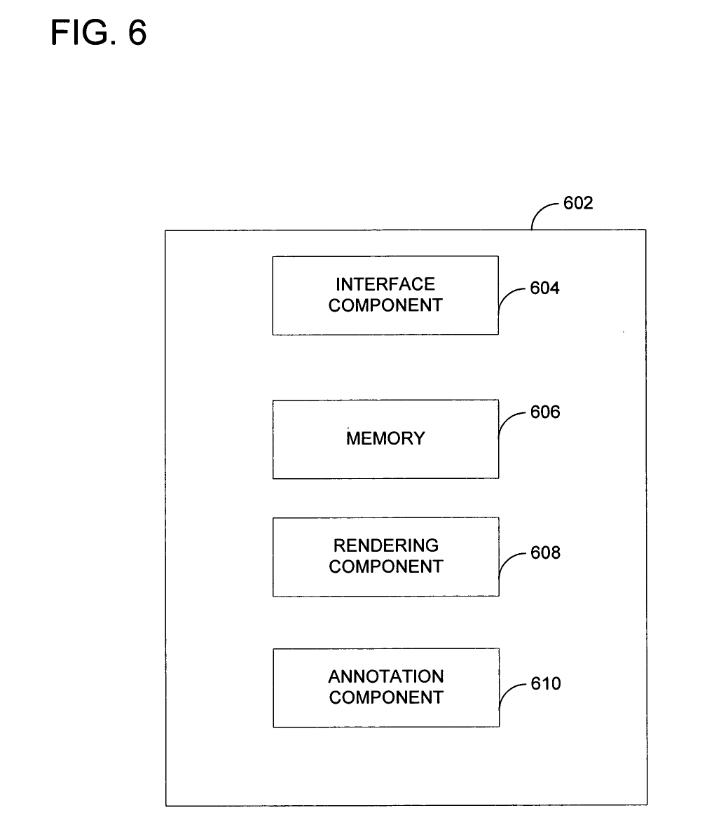

FIG. 6 is a block diagram illustrating an exemplary computer-readable storage medium 602 on which aspects of the invention may be stored. An interface component 604 captures annotating data from a user for annotating a media data stream. A memory 606 stores the media data stream, said media data stream including media data organized in one or more segments. A rendering component 608 renders the media data stream. An annotation component 610 identifies a time period when the annotating data is captured. The identified time period is relative to a time corresponding to the one or more segments of the media data as the media data stream is being rendered. The annotation component 610 organizes an annotating data stream including the annotating data synchronized with the media data stream based on the identified time period, and the interface component 604 provides the annotating data stream to the user.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

APPENDIX A

private InkCollector VideoInk; // Collects ink drawn over video
private InkCollector WhiteboardInk; // Collects ink drawn on
whiteboard
private InkDataQueueInkQueue; // A queue that holds collected ink
data

| | |
|---|---|
| private WMPlayer | Player;// Handles playback of video |

```
// video or the whiteboard area in the application.
public _value enum InkTarget : System::Byte
{
  Video = 0,
  Whiteboard = 1
};
// InkData: Defines a data packet for one frame of ink.
public _gc class InkData
{
  public:
```

| InkTarget target; | |
|---|---|
| BYTE ink_data __gc [ ]; // data | |
| LONGLONG time; | // Time captured |
| bool keyframe; | // True for keyframe, this value is |

set during encoding.

```
};
// The timer fires many times per second. Typical frequency might
be 15 or 30.
public void OnTimer(object source, System.Timers.ElapsedEventArgs
e)
{
  if( Player != null && Player.HasInkStream == false )
  {
```

```
if( Player.State == PlayerState.Running )
{
  long time = CachedPlayerPosition;
  if( VideoInk.CollectingInk == true )
  {
```

SaveInk(InkTarget.Video, time);

```
  }
  if( WhiteboardInk.CollectingInk == true )
  {
```

SaveInk(InkTarget.Whiteboard, time)

}
}

```
  }
}
// Retrieves the ink data and adds it to the queue.
private void SaveInk(InkTarget target, long time)
{
  InkData data = new InkData( );
  data.ink_data =
  VideoInk.Ink.Save(PersistenceFormat.InkSerializedFormat);
  data.time = time;
  data.target = target;
  InkQueue.Enqueue(data);
}
```

What is claimed is:

1. A computer-implemented method for annotating media data, said computerized method comprising:
rendering a media data stream, said media data stream including media data being rendered in one or more segments;
receiving annotating data from a user for annotating the media data;
identifying a time period when the annotating data is received, said identified time period being relative to a time corresponding to the one or more segments of the media data as the media data stream is being rendered; and
organizing an annotating data stream including the annotating data synchronized with the media data stream based on the identified time period.

2. The computerized method of claim 1 further comprising capturing one or more segments of the annotating data and organizing the captured segments in a data structure, said captured segments of the annotating data matching the one or more segments of the media data stream as a function of the time as the media data stream is rendered.

3. The computerized method of claim 2 further comprising removing the captured segments in the data structure.

4. The computerized method of claim 1 wherein receiving annotating data comprises receiving data representing one or more of the following: digital ink strokes, audio data stream, and video data stream, and wherein rendering the media data stream comprises rendering media data including at least one or more of the following: an audio file, a video file, an audio data stream, and a video data stream.

5. The computerized method of claim 1 further comprising rendering the organized annotating data stream with the media data stream synchronously, and further comprising generating an annotated media file including the organized annotating data stream and the media data stream.

6. The computerized method of claim 1 further comprising generating an output file including the organized annotating data stream and the media data stream.

7. The computerized method of claim 1 wherein one or more computer-readable media have computer-executable instructions for performing the computerized method recited in claim 1.

8. A system for rendering digitally annotated media stream, said system comprising:
an interface for receiving the annotated media stream, said annotated media stream including an annotating data stream and a media data stream;
a processor for executing computer-executable instructions for:
identifying the annotating data stream, said annotating data stream including one or more segments each having a time stamp associated therewith;
rendering the media data stream, said media data stream including media data being rendered in one or more segments;
rendering the one or more segments of the annotating data stream and the one or more segments of the media data stream synchronously by associating each of the time stamps of the annotating data stream with each of the segments of the media data stream as the media data stream is rendered; and
a user interface for providing the rendered annotating data stream and the rendered media data stream to a user.

9. The system of claim 8 further comprising a memory for storing the annotating data stream in a data structure and the media data stream as the processor renders the annotating data stream and the media data stream, said data structure includes one or more data fields having data associated with one or more of the following: delta frames, key frames, digital ink segments, source digital ink segment, size of original digital ink segment, placement of original digital ink segment, and timestamp.

10. The system of claim 8 further comprising a plug-in component for rendering the annotating data stream with the media data stream synchronously.

11. The system of claim 8 wherein the annotating data stream comprises data representing one or more of the following types: digital ink strokes, audio data stream, and video data stream.

12. The system of claim 11 wherein the processor is further configured to identify the types of the annotating data stream, and wherein the processor is further configured to generate an annotated media file including the organized annotating data stream and the media data stream.

13. The system of claim 12 wherein the user interface includes one or more of the following to provide the annotating data stream according to the types: a media player application program, a whiteboard application program, a microphone, or a communication source.

14. The system of claim 8 wherein the media data stream comprises at least one or more of the following: an audio file, a video file, an audio data stream, and a video data stream.

15. A computer-readable storage medium having computer-executable components for annotating a media data stream, said computer-executable components comprising:
an interface component for capturing annotating data from a user for annotating the media data stream;
a memory for storing the media data stream, said media data stream including media data organized in one or more segments;
a rendering component for rendering the media data stream;
an annotation component for identifying a time period when the annotating data is captured, said identified time period being relative to another time period corresponding to the one or more segments of the media data as the media data stream is being rendered;
wherein the annotation component organizes an annotating data stream including the annotating data synchronized with the media data stream based on the identified time period, and wherein the interface component provides the annotating data stream to the user.

16. The computer-readable storage medium of claim 15 wherein:
the rendering component further renders the annotating data stream and the media data stream synchronously and further generates an annotated media file including the organized annotating data stream and the media data stream, and
the interface component is further configured to provide the annotating data stream and the media data stream to the user.

17. The computer-readable storage medium of claim 15 further comprising a plug-in component for rendering the annotating data stream with the media data stream synchronously.

18. The computer-readable storage medium of claim 15 wherein the memory stores the annotating data in a data structure, said data structure includes one or more data fields having data associated with one or more of the following: delta frames, key frames, digital ink segments, source digital ink segment, size of original digital ink segment, placement of original digital ink segment, and timestamp, and wherein the annotating data comprises data representing one or more of the following: digital ink strokes, audio data stream, and video data stream, and wherein the media data stream comprises at least one or more of the following: an audio file, a video file, an audio data stream, and a video data stream.

19. The computer-readable storage medium of claim 15 wherein the interface component further captures one or more segments of the annotating data to be stored in a data structure, said one or more captured segments of the annotating data matching the one or more segments of the media data stream as a function of the time as the media data stream is rendered.

20. The computer-readable storage medium of claim 15 wherein the interface component includes a media player application program, a whiteboard application program, a microphone, or a communication source.
